(19) United States
(12) Patent Application Publication
(10) Pub. No.: US 2013/0089494 A1
(43) Pub. Date: Apr. 11, 2013

(54) COPPER-CONTAINING KFI-TYPE ZEOLITE AND USE IN SCR CATALYSIS

(71) Applicants: Markus Reichinger, Munchen (DE); Gerd Maletz, Bad Aibling (DE); Kristof Eisert, Munchen (DE)

(72) Inventors: Markus Reichinger, Munchen (DE); Gerd Maletz, Bad Aibling (DE); Kristof Eisert, Munchen (DE)

(73) Assignee: SUD-CHEMIE IP GMBH & CO. KG, Munchen (DE)

(21) Appl. No.: 13/578,081

(22) PCT Filed: Feb. 10, 2011
(86) PCT No.: PCT/EP11/51940

§ 371 Date: Dec. 28, 2012

(30) Foreign Application Priority Data
Feb. 11, 2010 (DE) 10 2010 007 626.0

(51) Int. Cl. B01J 29/88; B01J 29/76

(52) U.S. Cl. CPC B01J 29/88; B01J 29/76
USPC 423/700; 423/213.2; 422/168

(57) ABSTRACT

The present invention relates to a copper-containing KFI-type zeolite, wherein the zeolite contains 1 to 4.5 wt.-% copper. The invention is also directed towards a method for producing the copper-containing zeolite according to the invention as well as towards the use of the zeolite in SCR catalysis. Further subjects of the invention are a washcoat which contains the zeolite according to the invention, an SCR catalyst which contains the zeolite according to the invention as well as an exhaust-gas cleaning system which comprises the SCR catalyst.

The present invention relates to a copper-containing KFI-type zeolite, wherein the zeolite contains 1 to 4.5 wt.-% copper. The invention is also directed towards a method for producing the copper-containing zeolite according to the invention as well as towards the use of the zeolite in SCR catalysis. Further subjects of the invention are a washcoat which contains the zeolite according to the invention, an SCR catalyst which contains the zeolite according to the invention as well as an exhaust-gas cleaning system which comprises the SCR catalyst.

Since the start of exhaust-gas cleaning, great efforts have been made to ever further reduce the emission of pollutants by combustion engines. Measures inside the engine will in future no longer be sufficient to satisfy legal requirements. Therefore, modern systems are necessary for exhaust-gas after-treatment in order to be able to meet exhaust-gas limit values. For example, among others, the following systems for the exhaust-gas post-treatment of diesel engines are partly already realized or are in the testing phase:

Selective catalytic reduction (SCR method)

NOₓ reduction catalyst (NSR)

Oxidation catalyst (DOC)

Catalytically coated particle filter

Combinations such as, e.g. “Continuously Regenerating Trap” (CRT system), SCRT method, DPNR method.

The surface of the catalysts used in these systems has an active coating to accelerate the corresponding reactions. As a rule, ceramic or metallic monoliths serve as catalyst substrate to which the coating is applied.

A feature of diesel exhaust gases is their comparatively low temperature. In partial-load operation, the exhaust-gas temperature lies in the range between 120° C. and 250° C. and only at full load does it reach a maximum temperature between 550° C. and 650° C. Therefore it is necessary to use an SCR catalyst with a high low-temperature activity. In spite of this, the materials used are also to be highly active at high temperatures and in particular be highly resistant to ageing.

SCR (selective catalytic reduction) denotes the selective catalytic reduction of nitrogen oxides from exhaust gases of combustion engines and also power stations. Only the nitrogen oxides NO and NO₂ (called NOₓ in general) are selectively reduced with an SCR catalyst, wherein NH₃ (ammonia) is usually admixed for the reaction. Only the harmless substances water and nitrogen thus form as reaction product. The transportation of ammonia in compressed-gas bottles is a safety risk for use in motor vehicles. Therefore precursor compounds of ammonia which are broken down in the exhaust-gas system of the vehicles accompanied by the formation of ammonia are customarily used. For example the use of AdBlue®, which is an approximately 32.5% eutectic solution of urea in water, is known in this connection. Other ammonia sources are for example ammonium carbamate, ammonium formate or urea pellets.

Ammonia must first be formed from urea before the actual SCR reaction. This occurs in two reaction steps which together are called hydrolysis reaction. Firstly, NH₃ and isocyanic acid are formed in a thermolysis reaction. In the actual hydrolysis reaction isocyanic acid is then reacted with water to ammonia and carbon dioxide.

To avoid solid depositions it is necessary for the second reaction to take place sufficiently quickly by choosing suitable catalysts and sufficiently high temperatures (from 250° C.) Simultaneously, modern SCR reactors act as the hydrolysis catalyst.

The ammonia formed through thermohydrolysis reacts at the SCR catalyst according to the following equations:

4NO+4NH₃+O₂→4N₂+6H₂O (1)

NO+NO₂+2NH₃→2N₂+3H₂O (2)

6NO₂+8NH₃→7N₂+12H₂O (3)

At low temperatures (<300° C.) the conversion proceeds predominantly via reaction (2). For a good low-temperature conversion it is therefore necessary to set an NO₂:NO ratio of approximately 1:1. Under these conditions the reaction (2) can already take place at temperatures from 170-200° C.

The oxidation of NO to NOₓ takes place in an upstream oxidation catalyst which is necessary for an optimum degree of efficiency.

If more reductant is added than is converted during the reduction with NOₓ, an undesired NH₃ slip may thus result. The removal of the NH₃ can be achieved by an additional oxidation catalyst behind the SCR catalyst. This barrier catalyst oxidizes any ammonia that may occur to N₂ and H₂O. It is also essential that the urea dose be applied carefully.

An important characterizing variable for SCR catalysis is the so-called feed ratio a, defined as the molar ratio of added NH₃ to the NOₓ present in the exhaust gas. Under ideal operating conditions (no NH₃ slip, no secondary reactions, no NH₃ oxidation), a is directly proportional to the NOₓ reduction rate.

With α=1 a one hundred per cent NOₓ reduction is theoretically achieved. In practical use a NOₓ reduction of 90% can be achieved in stationary and non-stationary operation with an NH₃ slip of <20 ppm.

With today's SCR catalysts a NOₓ conversion >50% is achieved by the upstream hydrolysis reaction only at temperatures of above approx. 250° C., optimum conversion rates are achieved in a temperature range of from 250 -450° C.

The dosing strategy is very important in catalysts with large NH₃ storage capacity, as the NH₃ storage capacity of SCR catalysts of the state of the art typically falls as the temperature rises.

At present catalysts based on titanium dioxide, vanadium pentaoxide and tungsten oxide (VWT catalysts) are predominantly used both in the field of power stations and in the automobile field.

In addition to the VWT catalysts used thus far, metal-exchanged zeolites have proved promising catalysts in SCR catalysis.

By the term “zeolite” is generally meant, according to the definition of the International Mineralogical Association (D. S. Coombs et al., Can. Mineralogist, 35, 1997, 1571), a crystalline substance from the group of the aluminosilicates with a spatial network structure of the general formula

Mⁿ⁺[(AlO₂)ₓ(SiO₂)_{y}].z(H₂O)

which consist of SiO₄/AlO₄ tetrahedra which are linked by common oxygen atoms to form a regular three-dimensional network. The Si/Al=y/x ratio is always ≧1 according to the so-called “Löwenstein rule” which prohibits two neighbouring negatively charged AlO₄ tetrahedra from occurring next to each other. Thus, although more exchange sites are available for metals with a low Si/Al ratio, the zeolite becomes increasingly thermally unstable. Additionally, by the term “zeolite” is also meant, within the meaning of this invention, silicon aluminium phosphate (SAPO) and aluminium phosphates (AlPO) preferably with a KFI structure.

The zeolite structure contains cavities and channels which are characteristic of each zeolite. The zeolites are divided into different structures (see above) according to their topology. The zeolite framework contains open cavities in the form of channels and cages which are normally occupied by water molecules and extra-framework cations which can be replaced. An aluminium atom attracts an excess negative charge which is compensated for by these cations. The inside of the pore system represents the catalytically active surface. The more aluminium and the less silicon a zeolite contains, the denser is the negative charge in its lattice and the more polar its inner surface. The pore size and structure are determined, in addition to the parameters during production (use or type of templates, pH, pressure, temperature, presence of seed crystals), by the Si/Al ratio, which determines a large part of the catalytic character of a zeolite.

Because of the presence of e.g. 3-valent atoms (e.g. Al or Ga) the zeolite receives a negative lattice charge in the form of so-called anion sites in the vicinity of which the corresponding cation positions are located. The negative charge is compensated for by incorporating cations into the pores of the zeolite material. Zeolites are differentiated mainly according to the geometry of the cavities which are formed by the rigid network of the SiO₄/AlO₄ tetrahedra. The entrances to the cavities are formed by 8, 10 or 12 “rings” (narrow-, average- and wide-pored zeolites). Specific zeolites show a uniform structure (e.g. ZSM-5 with MFI topology) with linear or zig-zag channels, while in others larger voids attach themselves behind the pore openings, e.g. in the case of the Y and A zeolites with the topologies FAU and LTA.

Particularly iron- or copper-containing zeolites of the framework structure type MFI or BEA display a high activity with regard to NOₓ conversion, particularly in the low temperature range.

MFI or BEA have relatively large pore diameters. MFI for example 5.1 \acute{Å}×5.5 \acute{Å} and 5.3 \acute{Å}×5.6 \acute{Å} as well as BEA 6.6 \acute{Å}×6.7 \acute{Å} and 7.1×7.3 \acute{Å}. These large pore openings of the zeolite thus make possible the absorption of hydrocarbons which can penetrate into the pore system. However, an incomplete combustion of the hydrocarbons frequently takes place here which can lead to the formation of soot in the pores and thus blocks the active centres of the catalyst. This leads to sooting of the zeolite.

To solve this problem, WO 2008/132452 A2 proposes transition metal-containing zeolites which have a maximum ring size of 8 tetrahedral atoms. Here, a large number of possible framework structure types with ring openings with a maximum of 8 tetrahedral atoms are disclosed, wherein, however, only the zeolites SAPO-34, NU-3, SSZ-13, Sigma-1, ZSM-34 and CHA, which are exchanged either with iron or copper, are examined in more detail. However, the structure types used have certain disadvantages. Thus for example the zeolite SSZ-13 can be produced only by means of expensive organic templates, for example with 1-adamantamine, 2-quinuclidinol or 2-exo-aminonorbornane. U.S. Pat. No. 7,597,874 B1 discloses a synthesis of SSZ-13 using a quaternary ammonium salt and using seed crystals. However, the use of quaternary ammonium salts is always more cost-intensive than a template-free synthesis and, furthermore, the seed crystals must be produced beforehand in an additional method step, using organic templates.

SAPO-34 is a silicon-aluminium phosphate with CHA structure and can be produced without organic templates, but the ion exchange, in particular in the liquid phase, is associated with a considerable outlay due to the physical properties of the SAPO.

NU-3 displays a good low-temperature activity during NOₓ conversion, but this decreases rapidly in the higher temperature range. Likewise the zeolites Sigma-1 and SSZ-13 display a similar behaviour. The reduction at higher temperatures starting from approx. 350° C. also increases as a result of ageing.

The named small-pored zeolites display a better NOₓ conversion and a smaller N₂O formation compared with large-pored zeolites such as BEA, but as already stated above many of these zeolites can be produced only using expensive organic templates, display a poor performance or are unsuitable for use in exhaust-gas catalysis as for example fibrous, respirable structures are delivered into the environment and can thus cause damage to humans and animals.

Therefore, the object of the present invention was to provide a material which is suitable for SCR catalysis, which has a good low-temperature activity with only small losses at higher temperatures, displays a good ageing behaviour and can also be produced in cost-favourable manner.

The object was achieved by a copper-containing KFI-type zeolite, wherein the zeolite contains 1 to 4.5 wt.-%, preferably 1.5 to 4.2 wt.-%, even more preferably 2.5 to 4.0 wt.-% copper, relative to the total weight of the zeolite.

Surprisingly it was found that a copper-containing KFI-type zeolite which contains 1 to 4.5 wt.-% copper is extremely suitable for SCR catalysis. The copper-containing KFI-type zeolite displays a very good low-temperature activity, a high activity even in the high temperature range as well as only a slight ageing behaviour. The copper-containing zeolite according to the invention does not tend to soot, like large-pored zeolites, and is also characterized by a low formation of N₂O.

Thus far a KFI-type zeolite and in particular a copper-containing KFI-type zeolite could not be obtained with high purity in the state of the art. Frequently, phase impurities of the structure types MER, CHA, ERI and LTL are found in addition to the KFI structure type. The impurity can, however, be limited to phases of the MER structure type by a suitable choice of the reaction conditions. The MER proportion can further be reduced by thermal/hydrothermal treatment with the result that a higher phase purity of the KFI-type zeolite is achieved.

According to one embodiment it is preferred that the copper-containing zeolite has primary crystallites which lie in the range of from 0.2 to 10 μm, more preferably 0.25 to 7 μm, most preferably 0.5 to 5 μm.

The primary crystallites preferably have a cuboid morphology. In particular the primary crystallites have a cubic shape. These are three-dimensional structures, wherein in the case of the cuboid morphology a length-width ratio ≠1, preferably 0.7 to 1.3 and in the case of the cubic morphology, a length-width ratio of approximately 1 is preferred. In addition, two-dimensional structures, i.e. with only a slight vertical expansion of the primary crystallites, are also additionally possible. Thus these are small rectangular or square plates.

In a further embodiment it is preferred that the copper-containing zeolite contains iron. An advantage of the additional incorporation of iron into the zeolite is an increased catalytic activity in the high temperature range compared with the pure copper-containing zeolite.

The proportion of iron in the zeolite is preferably 0.01 to 6 wt.-%, more preferably 0.01 to 3.51 wt.-%. The proportion of copper and iron together is preferably 1.01 to 10 wt.-%, more preferably 1.01 to 4.51 wt.-%, relative to the total weight of the zeolite.

In a further advantageous embodiment of the invention it is preferred that the copper-containing zeolite has phase proportions of a zeolite of the MER structure type.

In one embodiment of the invention it is particularly preferred that the copper-containing KFI-type zeolite contains 1 to 4.5 wt.-% copper relative to the total weight of the zeolite, and also has a phase purity >50%, more preferably >60% and in particular >70%. According to an advantageous embodiment of the invention the zeolite according to the invention is preferably substantially a phase-pure KFI-type zeolite. Here, “substantially” means that it may contain phase proportions of zeolites of other structure types, e.g. MER, but these do not have any influence on the properties according to the invention of the KFI-type zeolite.

The copper or iron is present in the copper-containing zeolite according to the invention preferably in cationic form, either as metal cation or as cationic complex containing copper or iron as central metal. It is preferred that these cations compensate for the negative charge of the zeolite basic framework. The cations are present as counterions to the negative charges in the cavities of the zeolite.

A further subject of the invention is a method for producing a copper-containing zeolite characterized by the steps:
a) providing a KFI-type zeolite which can have phase proportions of an MER-type zeolite,
b) thermally treating or hydrothermally treating the zeolite at a temperature 500° C.

Likewise, the thermal and the hydrothermal treatments can be combined with one another, wherein either the thermal or the hydrothermal treatment can take place first.

Surprisingly it was found that under hydrothermal conditions the MER phase is slowly broken down as a result of the thermal treatment/hydrothermal treatment of the zeolite according to the invention. The SiO₂ formed during the breakdown of the MER phase can serve as binder proportion for a washcoat to be produced subsequently.

Replacing copper and optionally iron can, in the method according to the invention, take place before the thermal/hydrothermal treatment or after the thermal/hydrothermal treatment. Preferably, the replacement of copper and optionally iron can take place by a liquid-phase ion exchange. However, all other methods common to a person skilled in the art, such as for example a solid-state ion exchange, can also be undertaken.

The zeolite is preferably converted into the ammonium form before the copper and optionally iron are replaced. This method is known to a person skilled in the art.

The thermal/hydrothermal treatment takes place preferably over a period of from 30 minutes to 50 hours, more preferably 1 hour to 40 hours and most preferably from 2 hours to 30 hours. However, the thermal/hydrothermal treatment can also take place over a period longer than 50 hours. The longer the thermal/hydrothermal treatment takes, the more proportions of the MER phase are broken down, with the result that after a specific period of time preferably only a substantially pure KFI phase remains. For example, the increase in the proportion of the KFI phase (relative to the MER phase), or the reduction in the proportion of the MER phase, can be monitored via XRD. If all the MER signals in the XRD spectrum have disappeared, reference can be made to a phase-pure KFI zeolite.

As the MER phase is not particularly thermally/hydrothermally stable, the temperature can likewise be varied. Preferably, temperatures are 500° C., more preferably 550° C., even more preferably 600° C. and in particular 700° C. The temperature should, as far as possible, not exceed 1200° C., preferably 1100° C., even more preferably 1000° C., in particular 900° C.

The production of the KFI-type zeolite takes place preferably by converting a reaction mixture which contains strontium.

Additionally, sodium, potassium- and/or caesium cations can be used as template.

The reaction mixture or the synthesis gel generally contains:
an aluminium source,
a silicon source,
an alkali metal, preferably potassium, caesium, sodium or mixtures of at least two of those named,
strontium,
water.

Particularly preferred zeolites according to the present invention have the following proportions (molar ratios):

(K₂O+SrO)/SiO₂ 0.10-0.40

H₂O/(K₂O+SrO) 50-120

SiO2/Al₂O₃ 4-50

Usually, silicon dioxide is used as silicon source for the reaction mixture. A colloidal suspension of SiO₂, for example Ludox HS40 or AM-30, obtainable from E.I. Dupont de Nemours & Co. is most preferred here.

Preferably, Al(OH)₃, which is preferably dissolved in advance in alkali solution, is used as aluminium source. Al₂O₃×3H₂O is likewise suitable or aluminium in the form of metal which is likewise dissolved in alkali can be used.

The reaction mixture also preferably contains potassium in the form of potassium hydroxide. The strontium source is preferably strontium nitrate, although other strontium compounds, such as for example hydroxides, carbonates, oxides or sulphates can likewise be used.

Further, preferably bivalent metal cations can already be added to the reaction mixture during the synthesis of the KFI-type zeolite. Examples of this are calcium, magnesium and other alkaline-earth metals, copper, manganese, chromium, lead, iron, cobalt, nickel and zinc. Here, the metals can be incorporated directly into the framework of the zeolite. However, the proportion of these metals should not be too large, preferably in the range of from at most 1 to 1000 ppm. In particular, the metals influence the formation of the KFI-type zeolite.

The crystallization time also depends on the crystallization temperature. The crystallization is preferably carried out in the range of from approximately 90 to 200° C., more preferably 100 to 170° C., and at this temperature the crystallization is carried out over a period of preferably 12 to 240 hours, more preferably 24 to 130 hours. Lower temperatures require longer reaction times in order to achieve the same yield of the desired product. The crystallization is preferably carried out in a sealed autoclave under autogenic pressure. Lower pressures likewise require longer crystallization times.

After synthesis the obtained KFI-type zeolite is preferably converted into the ammonium form. Thereafter, copper and optionally iron can be replaced. As already stated above, the replacement of copper and optionally iron can already take place after the production of the copper-containing KFI-type zeolite, or only after the thermal treatment/hydrothermal treatment which leads to the MER phase either being reduced or disappearing.

The zeolite produced according to the invention is suitable as catalytically active component in SCR catalysis.

The zeolite according to the invention is thus suitable for reducing nitrogen oxide emissions of mobile or stationary combustion installations.

Mobile combustion installations within the meaning of the invention are for example vehicle combustion engines, in particular diesel engines, power generators based on combustion engines or other plants based on combustion engines. The stationary combustion installations are usually power stations, combustion plants, waste incineration plants and also heating systems for private households.

Thus a subject of the invention is also a method for reducing nitrogen oxide emissions in mobile or stationary combustion installations, wherein the method is characterized in that an exhaust-gas stream is conducted over a copper-containing zeolite according to the invention.

The copper-containing zeolite according to the invention is advantageously applied to a catalyst support. Suitable catalyst supports can be metallic or ceramic supports. Preferably the catalyst support is a monolithic support. The term then used is a so-called coating catalyst.

Generally, catalysts can be divided into bulk catalysts and coating catalysts. While bulk catalysts consist, to more than 50%, of a catalytically active material, coating catalysts consist of a catalyst support which can consist of a metal or a ceramic, wherein the surface of the catalyst support is provided with a coating. The coating is applied to the catalyst support with a so-called washcoat suspension, i.e. a suspension in a fluid medium. Usually, the applied washcoat suspension is then dried and calcined. The coating can then be impregnated with a further catalytically active component.

The subject of the invention is thus also a washcoat which contains the above-named copper-containing zeolite according to the invention. Preferably the D₅₀ value of the particles contained in the washcoat is approximately 2.5 to 7 μm, more preferably 3 to 5 μm. The D₉₀ value is preferably 7 to 12 μm, more preferably 7.5 to 9.5 μm, even more preferably 8 to 9 μm. The D₁₀ value is preferably 0.5 to 2.5 μm, more preferably 1.0 to 2 μm, even more preferably 1.3 to 1.7 μm.

The washcoat can contain a binder. Suitable binders, for example silica sols, are known to a person skilled in the art. In a further embodiment the washcoat is free of additional binder. The binder (here SiO₂) proportion is preferably already provided by the breaking-down of the MER phase during the thermal treatment of the zeolite according to the invention.

The washcoat can be applied to the support according to methods common to a person skilled in the art. Simple methods for this are for example the immersion of the support in the washcoat and the removal of excess washcoat by blowing out with air and extracting the air. It is likewise possible to carry out the coating using centrifuges or by spraying the support body with the washcoat.

By applying the washcoat to the support the finished SCR catalyst is obtained which is characterized in that it comprises the zeolite according to the invention or the above-named washcoat which contains the zeolite according to the invention. The same preferences as above for the zeolite and the washcoat apply here to the SCR catalyst.

A further subject of the invention is an exhaust-gas cleaning system which comprises the SCR catalyst according to the invention. The exhaust-gas cleaning system can also contain further components, preferably a diesel oxidation catalyst (DOC) for oxidizing hydrocarbons, a diesel particle filter for reducing particle emissions, optionally a hydrogenation catalyst for treating urea as well as a barrier catalyst following the SCR catalyst which serves as ammonium oxidation catalyst (slip catalyst).

The invention will now be explained with the help of some embodiment examples which are not to be understood as limiting the scope of the invention. Reference is additionally made to the figures. There are shown in:

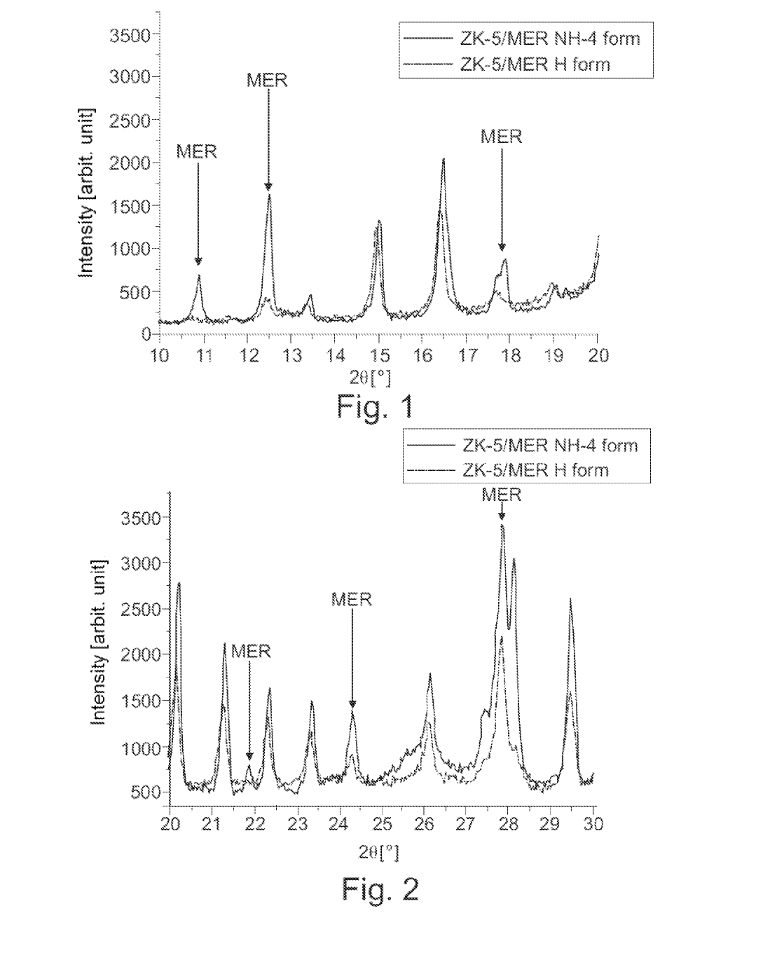

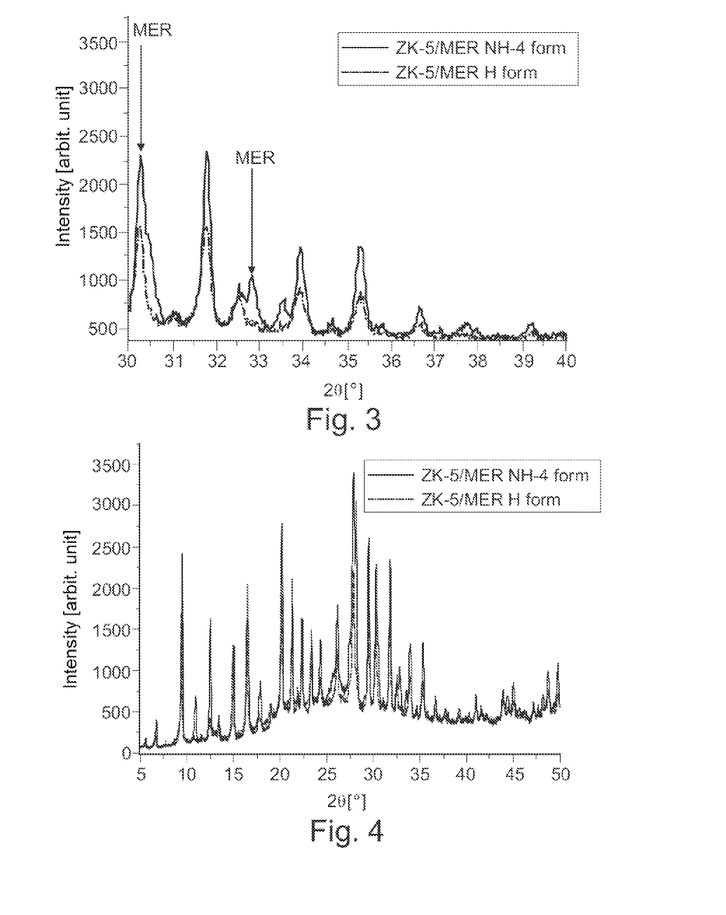

FIGS. 1 to 4 XRD spectra of a ZK-5 zeolite in the NH₄ form as well as after calcination at 500° C. in the H form.

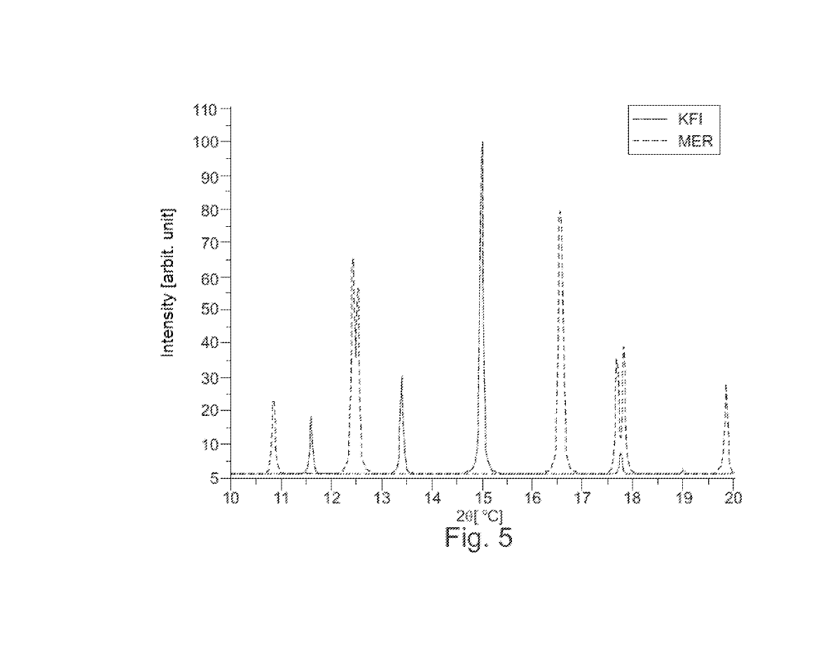

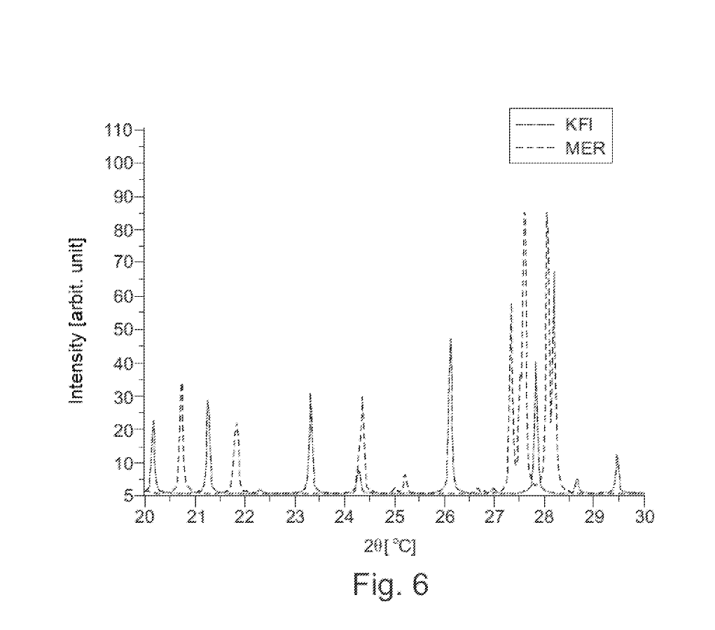

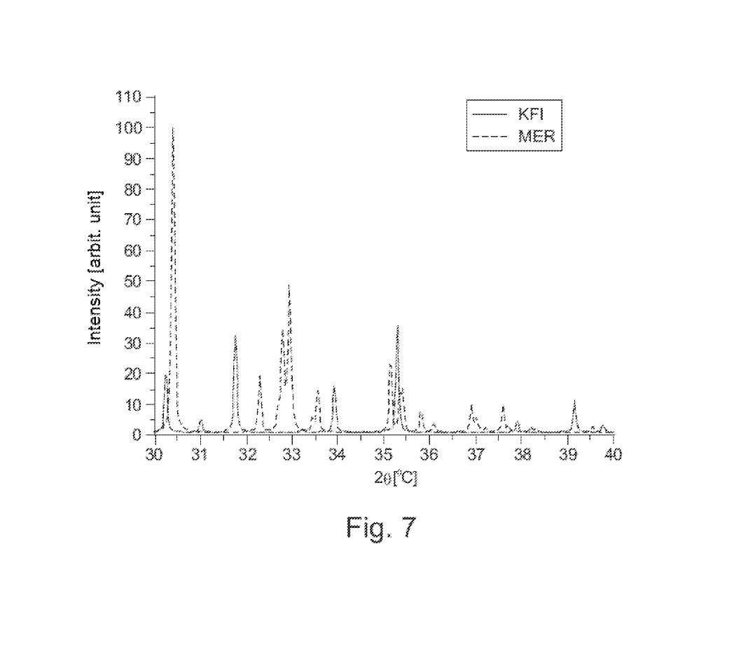

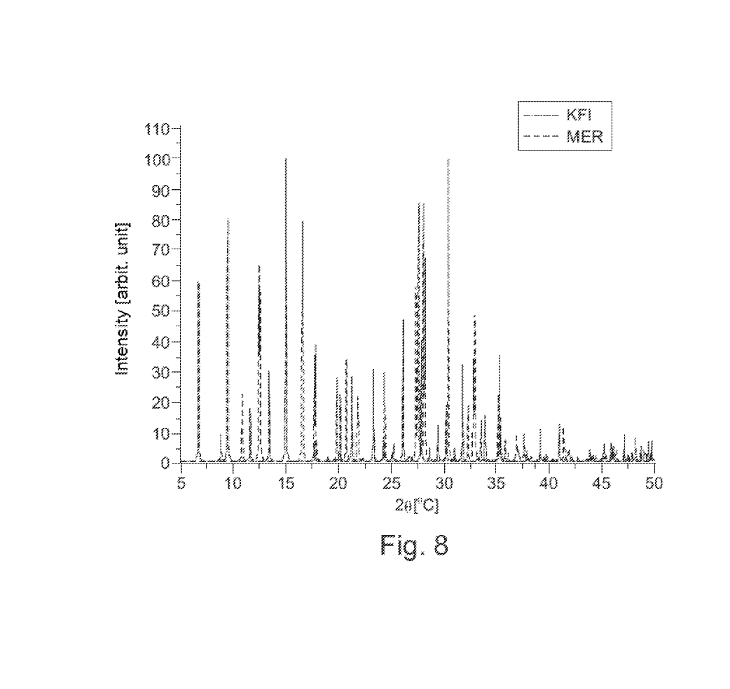

FIGS. 5 to 8 XRD comparison spectra of a KFI and an

MER zeolite.

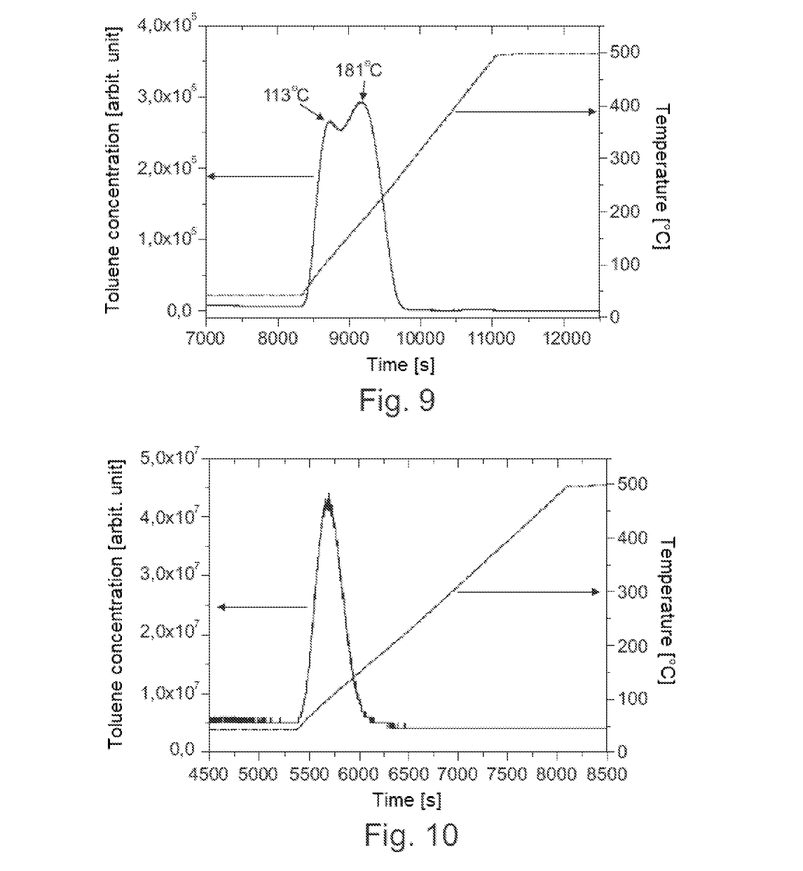

FIGS. 9 and 10 Toluene TPD spectra of an H-MFI (FIG. 9) and H-ZK5 zeolite (FIG. 10).

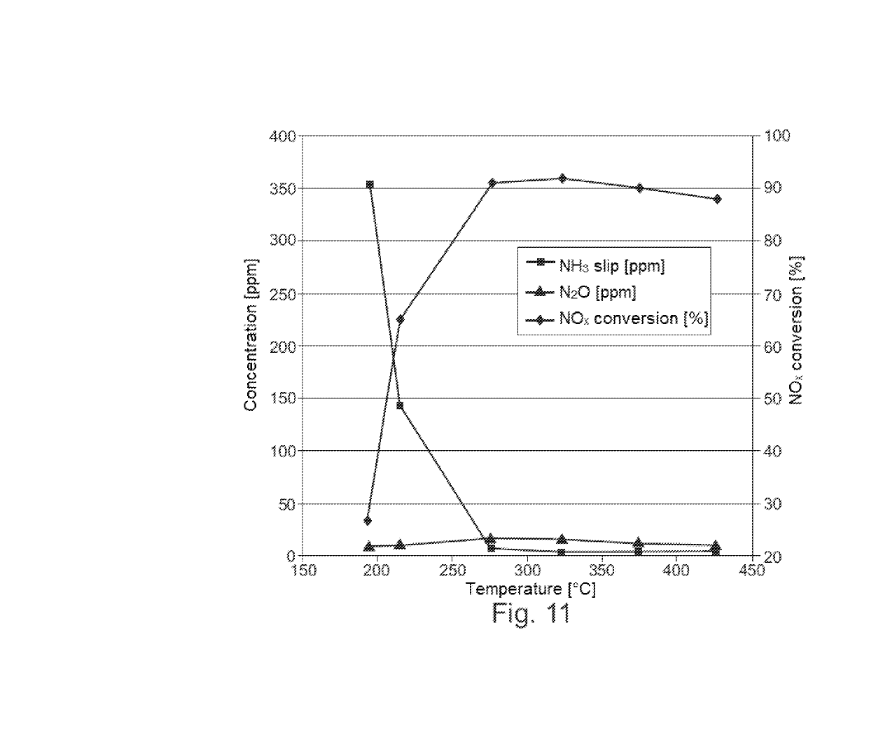

FIG. 11 the NOₓ conversion and the N₂O formation of a Cu-ZK-5 zeolite according to the invention as a function of the temperature.

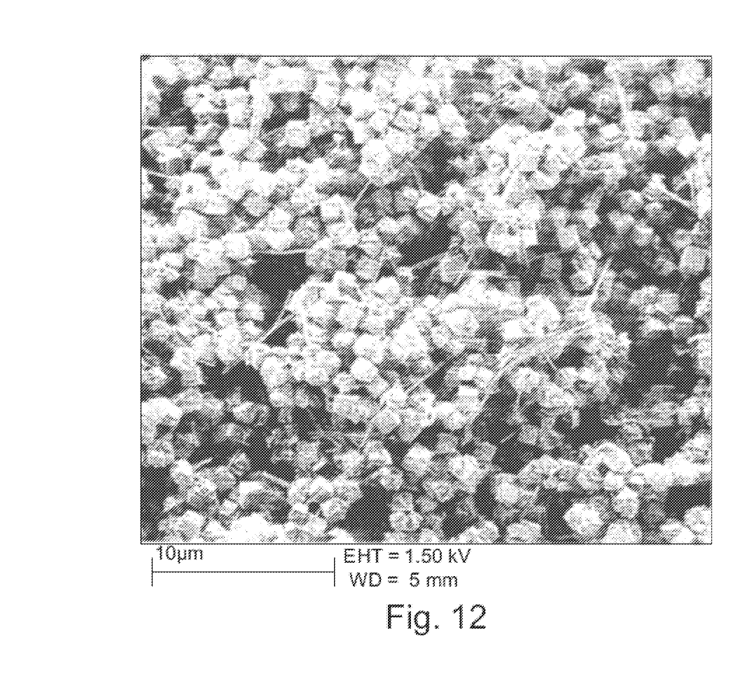

FIG. 12 a TEM picture of the Cu-ZK-5 zeolite according to the invention with cubic morphology.

### EMBODIMENT EXAMPLES

### Example 1

A Sr,K-ZK-5 zeolite was produced via a synthesis gel in which a solution containing potassium aluminate was mixed with a silica sol and a strontium nitrate solution. The aluminate solution was produced by dissolving Al(OH)₃ in aqueous potassium hydroxide (pellets, 85% dissolved in deionized water). This potassium aluminate solution was mixed with the strontium nitrate solution and a colloidal silica sol (e.g. AM-30, HS-30, HS-40 or LS-30) (Dupont). (Gel composition 2.3 K₂O:0.2Sr(NO₃)₂: 1 Al₂O₃: 12 SiO₂: 160 H₂O).

In a production variant (gel composition 2.3 K₂O:0.1 Sr(NO₃)₂: 1 Al₂O₃: 10 SiO₂: 160 H₂O) the aluminate solution was produced as follows: 1.149 g aluminium nitrate was dissolved in a solution containing 15.0 g deionized water and 6.463 g potassium hydroxide pellets. The aluminate solution was left to stand at 20° C. for two days until the wire was dissolved. The strontium nitrate solution was obtained by dissolving 4.455 g strontium nitrate (Sr(NO₃)₂, 99+%, Fluka) in 13.57 g deionized water. The Sr²⁺-containing silica solution was produced by adding strontium nitrate solution to 240.64 g Ludox AM-30. This suspension was then mixed with the aluminate solution. The resulting gel was shaken for six minutes. The crystallization was carried out at a temperature of 100 -190° C. in a noble-metal autoclave. The products were filtered, washed with deionized water and air-dried at 120° C. Each sample was measured with XRD.

The zeolite according to the invention can be produced very easily and economically, in particular by dispensing with costly organic templates, in contrast, for example, to SSZ-13 with CHA structure.

### Example 2

Ion Exchange on ZK-5 Zeolites

Firstly, the zeolite produced according to the invention was converted into the ammonium form.

130.0g ammonium nitrate was dissolved in 1170.0 g demineralized water and 130 g zeolite powder was added. The suspension was stirred on a magnetic stirrer. Then the suspension was heated to 80° C. accompanied by stirring and the batch stirred for an hour. The suspension was then filtered off, the filter cake washed with demineralized water and the process repeated twice. The filter cake was then dried overnight at 120° C.

The KFI-type zeolite used according to the invention is characterized by a problem-free ion exchange compared with for example SAPO-34.

FIG. 1 shows a ZK5 zeolite after ion exchange in the ammonium form, wherein the proportions of the structure type MER can still be seen. FIG. 1 shows the section for 2 theta of 10 -20°. After the zeolite was thermally treated (calcined) for eight hours at 500° C., a clear decline in the MER phase can be seen, whereas the signals for the KFI phase remain virtually stable. This decline can also be seen in the sections for 2 theta of 20 to 30° and 30 to 40° (see FIGS. 2, 3 or FIG. 4 which shows the complete range).

### Example 3

Copper Exchange

Batch size: 98.73 g

Cu content reference value [%]: 4.50

98.73 g zeolite powder was suspended in 500 ml demineralized water. 41.52 g copper tetramine hydroxide was added to this suspension and the batch was stirred for 16 hours. The suspension was then filtered off and the filter cake washed with demineralized water. The process was repeated once.

The filter cake was then transferred to a porcelain dish and dried overnight at 120° C. The copper content was 4.1%.

The KFI-type zeolite used according to the invention is characterized by a problem-free ion exchange compared with for example SAPO-34.

### Example 4

Production of a ZK5-Cu-Type Washcoat

38.98 g of the produced zeolite powder was suspended in a beaker with 85 g demineralized water. 29.2 g silica sol (Bindzil 2034 DI) and 4.8 g nitric acid (65% p.a.) was then added to the suspension. The suspension was then ground in a mill.

### Example 5

Measuring the NOₓ Conversion of the Cu-ZK-5

To determine the catalytic activity of the Cu-ZK-5 produced according to the invention a flow-through substrate (1 inch×2 inch, 400 cpsi) was coated with a Cu-ZK-5-based washcoat according to the invention and the catalytic activity measured. FIG. 11 shows the NOₓ conversion of the Cu-ZK-5 under the test conditions: a: 1.0, NOₓ: 500 ppm, GHSV=84000 1/h, O₂, CO₂ and H₂O each 5 vol.-%, NO₂/NOₓ=0.3.

| Temperature° C. | NOₓ conversion | NH₃ slip [ppm] | N₂O [ppm] |
|---|---|---|---|
| 194 | 0.27 | 355 | 10 |
| 215 | 0.65 | 143 | 11 |
| 276 | 0.91 | 7 | 17 |
| 323 | 0.92 | 4 | 16 |
| 374 | 0.90 | 4 | 12 |
| 426 | 0.88 | 5 | 11 |

### Example 6

Measuring the N₂O Formation

The N₂O formation on the Cu-ZK-5 according to the invention was also examined. FIG. 11 shows the N₂O formation of a Cu-ZK-5 produced according to the invention with 4.1 wt.-% copper. The chosen test conditions were as follows: a: 1.0, NOₓ: 500 ppm, GHSV=84000 1/h, O₂, CO₂ and H₂O each 5 vol.-%, NO₂/NOX=0.3.

A far clearer advantage is seen with the small-pored zeolite as SCR catalyst. The quantity of N₂O formed is very small and is in the same order of magnitude as with an iron-containing zeolite, while the small and medium-pored zeolites sometimes produce up to six times the quantity of N₂O. Additionally, the copper-containing ZK-5 has important advantages vis-à-vis for example an Fe-ZK-5 zeolite already known in the literature. Copper-containing zeolites have a clearly higher low-temperature activity, which is a decisively positive factor in SCR catalysis.

The zeolite according to the invention also has a sufficiently high hydrothermal stability compared with other small-pored zeolites such as for example MER or zeolite 3A.

### Example 7

Adsorption behaviour vis-à-vis hydrocarbons

Due to its molecular-sieve action, the zeolite according to the invention displays very largely no adsorption of higher hydrocarbons, e.g. branched long-chain aliphatics or also aromatics.

Toluene TPDs were measured in order to demonstrate the difference in adsorption behaviour. An H-MFI and an H-ZK-5 were examined.

The measuring took place as follows: The zeolite was heated in the inert gas stream and then charged with toluene. The sample was then heated and then an MS was used to register what quantity of toluene was desorbed at what temperature from the zeolite. The result is summarized in the following table and can also be seen in FIGS. 9 and 10:

| | Toluene desorption | Toluene desorption |
|---|---|---|
| Sample | [μmol] | [μmol/g sample] |
| H-MFI | 64 | 636 |
| H-ZK-5 | 0.518 | 5 |

It is seen that H-ZK-5 adsorbs almost no toluene, while with

MFI, which has larger pores, approximately 120 times as much toluene was adsorbed.

1. Copper-containing KFI-type zeolite, characterized in that the zeolite contains 1 to 4.5 wt.-% copper relative to the total weight of the zeolite.

2. Copper-containing zeolite according to claim 1, characterized in that the zeolite comprises primary crystallites with cuboid structure.

3. Copper-containing zeolite according to claim 1, characterized in that the zeolite comprises primary crystallites with cubic structure.

4. Copper-containing zeolite according to one claim 1, characterized in that the zeolite comprises primary crystallites with a size in the range of from 0.2 to 10 μm.

5. Copper-containing zeolite according to claim 1, characterized in that the zeolite contains iron.

6. Copper-containing zeolite according to claim 1, characterized in that the proportion of copper and iron together is 1.01 to 10 wt.-%, preferably 1.01 to 4.51 wt.-%, relative to the total weight of the zeolite.

7. Copper-containing zeolite according to claim 1, characterized in that the zeolite has phase proportions of a zeolite of structure type MER.

8. Copper-containing zeolite according to claim 1, characterized in that the zeolite is very largely free of phases of the structure types CHA, ERI and LTL.

9. Method for producing a copper-containing zeolite according to claim 1, comprising the steps:
providing a KFI-type zeolite which can have phase proportions of an MER-type zeolite,
thermally treating or hydrothermally treating the zeolite at a temperature ≧500° C.

10. Method according to claim 9, characterized in that a replacement of copper and optionally iron takes place before the thermal/hydrothermal treatment or after the thermal/hydrothermal treatment.

11. Method according to claim 10, characterized in that the zeolite is converted into the ammonium form before the copper and optionally iron are replaced.

12. Method according to claim 9, characterized in that the thermal/hydrothermal treatment takes place over a period of from 30 minutes to 50 hours.

13. Use of a zeolite according to claim 1 in SCR catalysis.

14. Washcoat containing a zeolite according to claim 1.

15. SCR catalyst containing a zeolite according to claim 1.

16. Exhaust-gas cleaning system containing the SCR catalyst according to claim 15.

17. SCR catalyst containing the washcoat according to claim 14.
